(19) United States
(12) Patent Application Publication
(10) Pub. No.: US 2007/0077023 A1
(43) Pub. Date: Apr. 5, 2007

(54) Image encoding apparatus, picture encoding method and image editing apparatus

(75) Inventor: Tomoyuki Okuyama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation

(21) Appl. No.: 11/541,548

(22) Filed: Oct. 3, 2006

(30) Foreign Application Priority Data
Oct. 3, 2005 (JP) 2005-289912

(51) Int. Cl. H04N 5/93

(52) U.S. Cl. 386/55

(57) ABSTRACT

An image encoding apparatus includes an editor for editing a coded stream encoded from non-compressed video data such that two edit points (A and B) are arranged in succession, a decoding processor for decoding an edited stream, and an encoding processor for encoding the edited coded stream. The encoding processor receives edited decoded data and inserts an insertion picture encoded from a decoded image J immediately previous to the point A between the points A and B, thereby creating the edited coded stream by aligning picture phases in such a way that a picture type is the same in the same frame between the original coded stream and the edited coded stream.

### BACKGROUND OF THE INVENTION

1. Field of the Invention

The present invention relates to an image encoding apparatus, image encoding method, and image editing apparatus capable of editing, decoding, and re-encoding the coded stream encoded from non-compressed video data.

2. Description of Related Art

With recent development in digital technology, digital sound/image recording and playback devices such as HDD (Hard Disc Drive), DVD (Digital Versatile Disc) and DVD player have been put to practical use. Such digital system compresses image data into a stream by MPEG (Moving Picture Experts Group) standards.

In the MPEG-2 (ISO/IEC13818-2) standard, a coded stream is formed of a combination of three types of pictures: an intra-coded picture (I-picture), a predictive-coded picture (P-picture) that is a picture which is coded using one-directional prediction from a reference frame, and a bi-directionally predictive-coded picture (B-picture) that is a picture which is coded using bi-directional prediction from reference frames.

A video stream of the MPEG-2 standard is coded in units of GOP (group of pictures). One GOP is composed of a series of pictures, normally 15, typically starting with an I-picture followed by a sequence of P- and B-pictures.

I-pictures are coded by intra-picture encoding without using prediction from a previous picture. I-pictures are produced as a result of intra-picture encoding without referring to another picture, and contains all the information necessary for decoding. P-pictures are encoded by inter-picture prediction with reference to past I- or P-pictures. They thus require information of the previously decoded I- or P-pictures which precede the relevant P-picture in the stream sequence. B-pictures are encoded by bi-directional inter-picture prediction with reference to both past and future I- or P-pictures. The decoding of B-pictures thus requires the previously decoded two pictures of I- or P-pictures which precede the relevant B-picture in the stream sequence.

If there is a B-picture, the encoding picture sequence and the display picture sequence do not correspond. Because a B-picture is decoded by referring to a picture which is displayed later than the relevant picture in the playback sequence, the reference I- or P-picture is placed ahead of the B-picture in the coding sequence. When editing the video stream which is produced by the MPEG-2 coding, because the reference pictures of the pictures encoded into P-pictures and B-pictures are altered by the editing, it is unable to extract data of necessary picture and simply concatenate them.

A moving picture which is coded by the MPEG standard may be edited in GOP unit simply. However, where there is a scene change in some part of GOP, it is unable to make an edit at that point. A method of editing a video stream for “bonding” an edit point in some part of GOP and an edit point in other part of GOP is disclosed in Japanese Unexamined Patent Application Publication No. 2002-300528 (Ichikawa et al.).

In the editing method taught by Ichikawa et al, a part or all of a first video stream and a part or all of a second video stream, which are respectively coded by inter-frame prediction, are “bonded” to produce a video stream which can be played back continuously. During this procedure, a first partial video stream that is composed of the pictures up to immediately previous to the picture which is coded by intra-frame prediction or one-directional inter-frame prediction is extracted from the first video stream. Further, a second partial video stream that is composed of the pictures subsequent to the picture which is coded by intra-frame prediction or one-directional inter-frame prediction is extracted from the second video stream. Then, it is determined as to whether the picture which is displayed immediately before the second partial stream extracted from the second video stream is an I-picture or not. If the relevant picture is an I-picture, it is determined as a first I-picture. If the relevant picture is not an I-picture, the pictures which are coded by one-directional inter-frame prediction are sequentially decoded starting from the I-picture immediately previous to the relevant picture up to the relevant picture, thereby obtaining a decoded image of the relevant picture. After that, the decoded relevant picture is re-encoded by intra-frame coding process, so that the re-encoded I-picture is inserted between the first partial stream extracted from the first video stream and the second partial stream extracted from the second video stream, thereby enabling editing in spite of a editing point existing in some part of GOP.

However, in the editing of such a stream including a coded picture, though it is possible to reduce the overall code length by eliminating a part of the stream, it is impossible to change a bit rate for encoding, which makes it difficult to adjust the code length after editing.

For example, when non-compressed digital video data is compression-encoded to GOP units, each composed of I-picture, B-picture and P-picture, by the MPEG standard or the like, and recorded on a recording medium such as a magneto-optical disc (MO disk), it is necessary to allow the data amount (bit amount) of compressed video data after compression encoding to fall below a recording capacity of a recording medium or a transmission capacity of a communication line while maintaining high quality of expansion-decoded video.

To achieve this, a coding method for a moving picture using pre-analysis may be employed. The coding method using pre-analysis first performs preliminary compression-encoding on non-compressed video data and estimates the amount of data after compression-encoding in a 1st pass. In a 2nd pass, the method adjusts a data compression ratio based on the estimated data amount and performs compression-encoding such that the amount of data after compression-encoding falls below a recording capacity of a recording medium. Such a compression-encoding method is referred to hereinafter as 2-pass encoding.

In the 2-pass encoding, it is necessary to consider a change in a buffer occupation rate due to allocation of a code length; otherwise, a buffer can break down due to overflow, underflow and so on during the actual encoding process. Even if a processing for preventing buffer breakdown is performed during the actual encoding process, a code length which is generated when encoding an image falls outside the range of a target code length, which hinders accurate control of the actual code length. In such a case, a code length which is different from a supposed code length to be allocated is actually allocated to an image, thus causing deterioration of image quality in encoding.

To overcome this drawback, a moving image encoding apparatus using pre-analysis for improving the quality of a coded image is disclosed in Japanese Unexamined Patent Application Publication No. 2002-232882 (Yokoyama). The moving image encoding apparatus taught by Yokoyama performs analysis on an image before encoding an input image to calculate complexity for each image. It then allocates a code length according to the calculated complexity at a time to the image within a prescribed interval and estimates a change in an occupation rate of the code length in a buffer. This prevents the buffer from breaking down to enable appropriate code allocation based on a given bit rate and buffer size, thereby improving the quality of a coded image.

However, in the 2-pass encoding described in Yokoyama, if the stream encoded in the 1st pass is edited in units of pictures, a picture phase subsequent to the edit point cannot correspond with a picture phase of the coded stream in the 1st pass after decoding the edited stream and re-encoding it. In such a case, the picture which is originally coded to a B-picture can be re-encoded as an I-picture, which causes deterioration of the image after editing. Further, because a picture phase of the edited stream does not correspond with a picture phase of a coded stream in the 1st pass which is pre-analyzed, it is unable to refer to the complexity for the pictures subsequent to the edit point and therefore unable to perform the 2-pass encoding on the edited stream.

### SUMMARY OF THE INVENTION

According to an aspect of the present invention, there is provided an image encoding apparatus including an editor for creating an editing instruction to edit a coded stream encoded from non-compressed video data at one or more edit point, a decoding processor for decoding the coded stream in accordance with the editing instruction to create an edited stream, and an encoding processor for re-encoding the edited stream to create an edited coded stream. The encoding processor creates the edited coded stream by aligning picture phases such that a picture type is the same in the same frame between the coded stream and the edited coded stream.

This invention enables alignment of picture phases when editing a coded stream encoded from non-compressed video data and re-encoding it, in such away that the same frame as in the original coded stream is encoded into the same picture, thereby preventing deterioration of image quality without encoding an originally B-picture into an I-picture, for example.

According to another aspect of the present invention, there is provided an image editing apparatus including an image encoding processor for editing a coded stream encoded from non-compressed video data, and two or more storage devices for storing a coded stream. The image encoding processor includes an editor for creating an editing instruction to edit the coded stream stored in one storage device at one or more edit point, a decoding processor for decoding the coded stream in accordance with the editing instruction to create an edited stream, and an encoding processor for re-encoding the edited stream to create an edited coded stream. The encoding processor creates the edited coded stream by aligning picture phases such that a picture type is the same in the same frame between the coded stream and the edited coded stream, and another storage device stores the edited coded stream.

This invention re-encodes the data edited from the original coded stream stored in one storage device by aligning picture phases so that the picture is the same as in the corresponding frame of the original coded stream, thereby enabling dubbing of the data into another storage device without deteriorating image quality. Further, because the edited stream is encoded by aligning picture phases such that the same frame is encoded into the same picture type as in the coded stream, if complexity of each frame is analyzed when creating the original coded stream, it is possible to implement 2-pass encoding on the edited stream.

According to this invention, even if an edit is made at an optional picture position in the coded stream, it is possible to align the picture phases of the coded stream obtained by encoding the stream after editing and the coded stream before editing, thereby suppressing deterioration of the re-coded image quality. Further, according to this invention, it is possible to, even after editing a coded stream, produce a stream having the same picture phase as in the coded stream before editing; therefore, if pre-analysis is made on the coded stream, the 2-pass encoding can be performed even after editing.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing an image encoding apparatus according to an embodiment of the present invention;

FIG. 2 is a block diagram showing a detail of an encoding processor of an image encoding apparatus according to an embodiment of the present invention;

FIG. 3 is a block diagram showing a detail of a decoding processor of an image encoding apparatus according to an embodiment of the present invention;

FIG. 4A is a view showing an original stream;

FIG. 4B is a view showing a GOP containing an edit point which is extracted from the original stream;

FIG. 4C is a view showing a part of a playlist after editing;

FIG. 5 is a view to describe a method of creating an edited stream in an image encoding apparatus according to an embodiment of the present invention, where a total number of pictures contained in a re-encoded picture group (n+(N−m+1))<N;

FIG. 6 is a similar view to describe a method of creating the edited stream, where (n+(N−m+1))>N;

FIG. 7 is a similar view to describe a method of creating the edited stream, where (n+(N−m+1))=2N;

FIG. 8 is a similar view to describe a method of creating the edited stream, where (n+(N−m+1))=N;

FIG. 9 is a similar view to describe a method of creating the edited stream, where an edit point B is present in a head GOP;

FIG. 10 is a similar view to describe a method of creating the edited stream, where an edit point A is present in a final GOP;

FIG. 11A is a flowchart showing an encoding process in the 2nd pass in an image encoding apparatus according to an embodiment of the present invention;

FIG. 11B is also a flowchart showing an encoding process in the 2nd pass in an image encoding apparatus according to an embodiment of the present invention;

FIG. 12A is a flowchart showing a calculation process for a target code length using complexity in an edited stream;

FIG. 12B is also a flowchart showing a calculation process for a target code length using complexity in an edited stream; and

FIG. 13 is a flowchart showing a calculation process for complexity of a frame which is inserted to an edited stream for aligning picture phases.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

An exemplary embodiment of the present invention is described hereinafter with reference to the drawings. In the below-described embodiment, the present invention is applied to a moving image encoding apparatus with edit function using 2-pass encoding.

An image encoding apparatus according to this embodiment offers 2-pass encoding. The 2-pass encoding process first estimates the amount of data after compression-encoding by preliminarily compression-encoding non-compressed audio/video data in the 1st pass. Then, in the 2nd pass, the process adjusts a data compression ratio based on the estimated data amount and implements compression-encoding such that the amount of data after compression-encoding falls below a recording capacity of a recording medium. Thus, in the 1st pass, when recording a title of non-compressed video data or the like after MPEG-encoding the title, for example, each frame is analyzed to obtain complexity (pre-analysis), and the complexity is recorded together with the MPEG-coded title. In the 2nd pass, encoding is implemented with a code length being allocated according to the complexity such that a bit rate is a prescribed value. Allocating a code length using the complexity enables improvement of an image quality with a limited bit rate and thus prevents underflow or overflow from occurring in a buffer.

The image encoding apparatus of this embodiment is capable of performing the above-described 2-pass encoding in creating a playlist or an edited title which is produced by editing a recorded MPEG-coded title (program) in units of pictures.

Normally for a pre-analyzed coded stream, complexity is calculated for each frame. Each frame is encoded into a prescribed picture type, having complexity in accordance with each picture type. Therefore, if the coded stream is edited and decoded at some point of GOP, when re-encoding the edited title, the frame corresponding to the coded stream before editing is not encoded into the same picture type. For example, the frame which is originally coded to a B-picture can be undesirably coded to an I-picture, which causes deterioration of picture quality in the edited coded stream.

Further, if, in the coded stream after editing, a corresponding frame or the same image as in a pre-analyzed coded stream before editing is encoded into a picture of a different type, the 2-pass encoding which encodes data by setting an optimum target code length using a result of pre-analysis cannot be implemented. On the other hand, in the image encoding apparatus of this embodiment, a prescribed picture (referred to herein as an insertion image) is inserted into an edited coded stream so as to align picture phases such that a corresponding frame is encoded into a picture of the same type as in the pre-analyzed coded stream before editing. Specifically, aligning picture phases means that, in the process of decoding a component picture which forms a coded stream and re-encoding it, the re-encoding provides the same picture type as that of the component picture. If the picture phases are aligned, it is possible to refer to the pre-analysis result of the coded stream before editing in the process of re-encoding the pre-analyzed coded stream after editing it by providing an edit point in some part of GOP, thus enabling 2-pass encoding.

In the followings, descriptions are given firstly on the structure of the image encoding apparatus according to this embodiment, then on a method of aligning the picture phase of a MPEG stream after editing (referred to herein as an edited coded stream ST1) with the picture phase of a MPEG stream before editing (referred to herein as an original stream ST0), and finally on a method of implementing 2-pass encoding on an edited stream using a result of pre-analysis on an original stream.

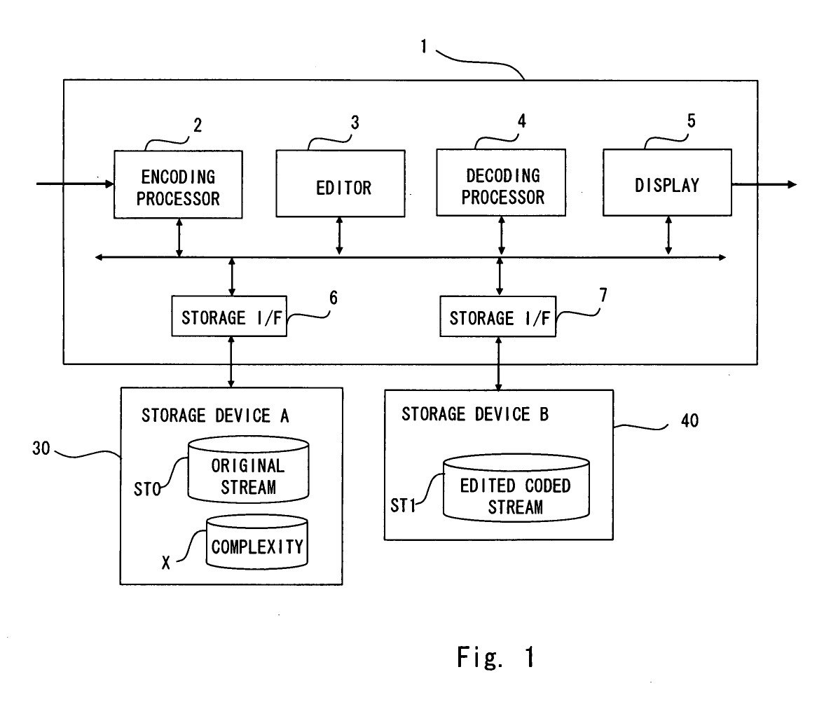

FIG. 1 is a block diagram showing an image encoding apparatus according to this embodiment. The image encoding apparatus 1 includes an encoding processor 2, an editor 3, a decoding processor 4, a display 5, and a storage interfaces (I/F) 6 and 7. The display 5 may be a separated unit from the image encoding apparatus 1. Though two storage I/Fs are illustrated in FIG. 1, the number of storage I/Fs may be more than two. The storage I/F 6 may be connected to a storage device 30 such as HDD, and the storage I/F 7 may be connected to a storage device 40 such as DVD recorder, for example. The storage devices 30 and 40 may be included in the image encoding apparatus 1.

In the image encoding apparatus 1 of this embodiment, the encoding processor 2 encodes input non-compressed video data by the MPEG standard and stores the MPEG-coded data into the storage device 30, 40, and the editor 3 edits the coded stream stored in the storage device 30, 40. Then, the decoding processor 4 decodes the coded stream, and the display 5 displays (playbacks) the result. As described above, the image encoding apparatus 1 is capable of editing a coded stream (referred to herein as an original stream) which is created by encoding video data in the encoding processor 2 to thereby create an edited coded stream ST1 in such a way that the picture phases of the original stream ST0 and the edited coded stream ST1 are aligned. For example, a frame which is encoded into an I-picture in the original stream ST0 can be re-encoded into an I-picture again in the edited stream.

Accordingly, if the complexity is analyzed when creating the original stream ST0 and stored together with the original stream ST0, it is possible to refer to the complexity when creating the edited stream ST1. This enables allocation of an optimum code length in accordance with the complexity and consequently enables implementation of 2-pass encoding which encodes with a controlled a code length when creating the edited coded stream ST1. This suppresses deterioration of image quality even if a bit rate is smaller than the rate used when encoding the original stream, thereby allowing recording on a medium with a limited storage capacity such as DVD.

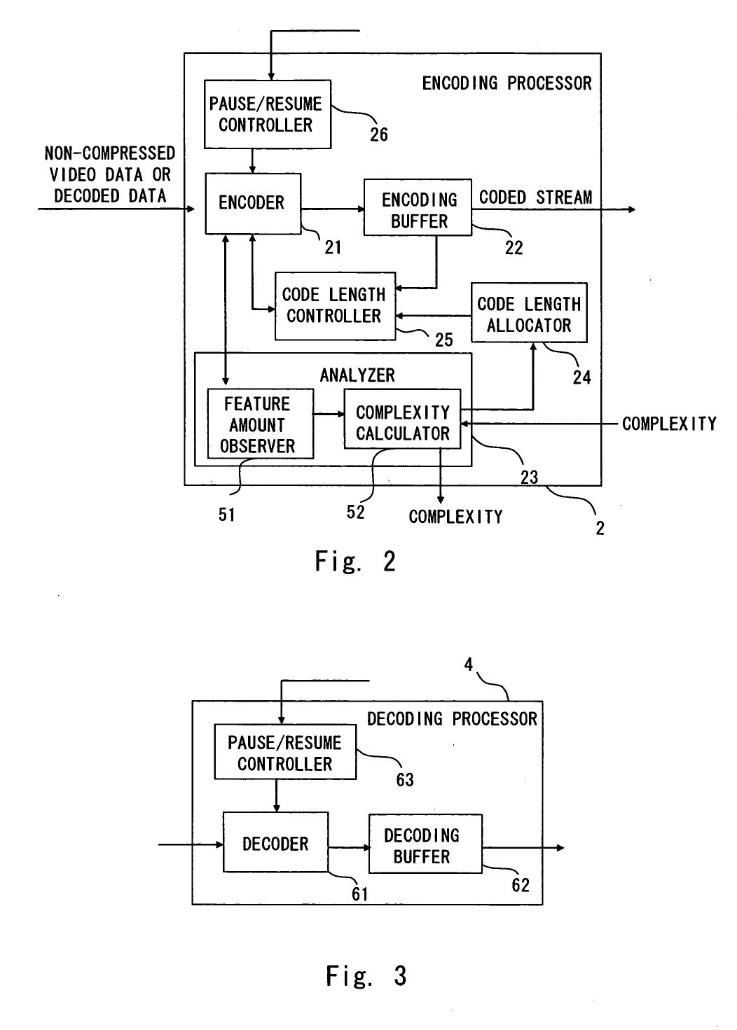

Each block is described hereinafter in detail. FIG. 2 is a block diagram showing a detail of the encoding processor 2. As shown in FIG. 2, the encoding processor 2 includes an encoder 21, an encoding buffer 22, an analyzer 23, a code length allocator 24, a code length controller 25, and a pause/resume controller 26. The encoder 21 receives non-compressed video data supplied from outside or decoded data from the decoding processor 4 and MPEG-encodes the data. The encoding buffer 22 temporarily stores the encoded data. The analyzer 23 analyzes information for encoding and calculates complexity. The code length allocator 24 allocates a target code length for each picture based on complexity, thus enabling 2-pass encoding. The code length controller 25 controls the encoder 21 to perform encoding with a code length indicated by a controller (not shown) or a code length allocated by the code length allocator 24. The pause/resume controller 26 controls a timing to pause and resume the encoding procedure during the process of the 2-pass encoding so that picture phases before and after editing correspond to each other.

When recording a title, the encoding processor 2 typically MPEG-encodes the input non-compressed video data with a relatively high bit rate, for example, and stores the coded stream (original stream) to the storage device 30 having a large storage capacity such as HDD through the storage I/F 6. In this process, the analyzer 23 analyzes complexity X based on a code length which is generated when encoding each frame of the video data into a prescribed picture and a quantization scale. The complexity X indicates complexity when encoding each frame into a picture of a prescribed picture type, which is associated with each picture. The complexity X is stored in the storage device 30 together with the original stream. The complexity X may be stored in a memory (not shown) disposed in the apparatus rather than in the storage device 30.

The analyzer 23 includes a feature amount observer 51 and a complexity calculator 52. The feature amount observer 51 observes a generated code length and an average quantization scale of an image, which are a feature amount. For example, the feature amount observer 51 observes a generated code length S[f] and an average quantization scale Q[f] of each frame f which occur when the encoder 21 encodes a title composed of non-compressed video data based on a given bit rate R under control of the code length controller 25.

The complexity calculator 52 calculates complexity based on the generated code length and the average quantization scale which are observed by the feature amount observer 51. For example, where generated code length is S[f], average quantization scale is Q[f], and complexity is X[f], the complexity X[f] can be calculated as follows:
X[f]=S[f]*Q[f]

A specific calculation method for complexity X to obtain a target code length for 2-pass encoding is described in Yokoyama, for example. Normally, the code length allocator 24 calculates a target code length from the complexity calculated as above, which is used during the 2-pass encoding as a target value.

As described later, an insertion image is inserted into an edited stream in the position previous to and/or subsequent to an edit point according to need in order to align the picture phase of the edited stream with the picture phase of the original stream. When encoding the edited stream to create an edited coded stream ST1, the complexity calculator 52 of this embodiment refers to the complexity which is analyzed when creating the original stream ST0 and supplies the complexity of the frame corresponding to the original stream to the code length allocator 24. The complexity calculator 52 also calculates complexity for encoding an insertion image to create a picture (referred to hereinafter as an insertion picture) from the complexity of the original stream and supplies the calculated complexity to the code length allocator 24.

The code length allocator 24 allocates a target code length when encoding frames to create pictures based on the complexity supplied from the complexity calculator 52. The target code length may be such that a total code length which can be used in an allocation interval of a code length corresponding to a prescribed GOP length is allocated in accordance with complexity for each image. If an allocation interval of a code length is L frame and a total code length which can be allocated to frames from a f-th frame to a (f+L−1)th frame is Ra[f], a target code length T[f] of each frame which is a result of allocating Ra[f] in proportion to complexity X[f] can be calculated as:
T[f]=(X[f]/Xsum)*Ra[f]
where a total of complexity X[f] in an allocation interval is Xsum.

In the 1st pass encoding, the code amount controller 25 controls the encoding processor 2 to perform encoding with a bit rate which is predetermined or indicated from outside. In the 2nd pass encoding, the code amount controller 25 calculates a quantization scale based on the information from the code amount allocator 24 and controls to perform encoding with the calculated quantization scale. At the same time, an actual code length is measured and, if there is a difference between the actual code length and an allocated code length, feedback control is performed for controlling the code length to as to approximate a prescribed bit rate, thereby performing encoding with a target code length. In a simple process, if an actual code length exceeds a target code length, a quantization scale is enlarged to suppress the generation of a code; if an actual code length falls below a target code length, a quantization scale is reduced to increase the generation of a code.

Further, the code amount controller 25 monitors an occupation rate of the encoding buffer 22 and implements control such as adjustment of a quantization scale and stuffing as needed so that an actual code length which is generated as a result of encoding does not cause overflow or underflow in the encoding buffer 22. For example, in order to prevent the encoding buffer 22 from overflowing, the code amount controller 25 enlarges a quantization scale to suppress the generation of a code or does not encode the information which is supposed to be encoded to suppress the increase in an actual code length. On the other hand, in order to prevent the encoding buffer 22 from underflowing, the code amount controller 25 reduces a quantization scale to increase the generation of a code or performs stuffing to increase an actual code length.

The encoder 21 encodes the non-compressed video data supplied from outside or decoded data sent from the decoding processor 4 according to a given parameter to thereby generate compressed date. The encoder 21 further measures a generated code length and notifies it to the code amount controller 25. In addition, in the encoding of the 1st pass, the encoder 21 notifies a generated code length and an average quantization scale to the feature amount observer 51.

The encoding buffer 22 may accumulate the data encoded by the encoder 21 and output the data at a fixed bit rate. The encoding buffer 22 can absorb the variation in a generated code length per image.

Referring back to FIG. 1, the decoding processor 4 decodes the MPEG stream which is stored in the storage device 30, 40 so that it is displayed in the display 5, and also supplies the coded stream to the encoding processor 2 so that it is re-encoded. FIG. 3 is a block diagram showing a detail of the decoding processor 4.

The decoding processor 4 includes a decoder 61, a decoding buffer 62, and a pause/resume controller 63. The decoder 61 decodes a coded stream which is encoded by the encoding processor 2 or a coded stream which is stored in the storage device 30, 40. The decoding buffer 62 temporarily stores decoded audio/video data. The pause/resume controller 63 controls a timing to perform decoding by the decoder 61.

When executing the 2-pass encoding described above, the decoding processor 4 decodes an original stream ST0 which is encoded in the 1st pass. If the encoding processor 2 creates the edited coded stream ST1, the editor 3 sequentially supplies GOP to the decoding processor 4 in accordance with an edit instruction (playlist), which is a virtual title, created by the editor 3, and the decoding processor 4 decodes them. At this time, if an edit point is in some part of GOP, the pause/resume controller 63 controls to repeatedly output an immediately previous decoded image, output only a decoded image which is necessary for an edited coded stream or the like as described later. The coded data (edited stream) which is decoded and output by the decoding processor 4 in this manner is then encoded into the edited coded stream ST1 by the encoding processor 2.

Referring back again to FIG. 1, the editor 3 creates a playlist which serves as a virtual title so as to edit the original stream stored in the storage device 30 at a desired point. The editor 3 of this embodiment can control the encoding processor 2 and the decoding processor 4 so as to 2-pass encode the video which is edited according to the playlist. A controller for controlling the decoding processor 4 and the encoding processor 2 may be placed separately. A detail of the control process is detailed later.

When creating the edited coded stream ST1, the editor 3 may receive from a user an instruction about cutting a portion between desired edit points, an instruction about a bit rate for creating the edited coded stream ST1, and so on. The editor 3 creates a playlist in accordance with the instruction about the edit point, thereby editing the original stream ST0. The editor 3 further supplies GOP of the original stream ST0 to the decoding processor 4 in accordance with the created playlist, so that the display 5 can playback the edited stream. When executing the 2-pass encoding on the edited stream, the editor 3 controls the decoding processor 4 to output the edited stream and the encoding processor to perform 2-pass encoding thereon. Specifically, an appropriate bit rate is indicated so that the edited coded stream ST1 after encoding has a desired data size, a target code length in accordance with complexity X is allocated, and the edited stream is encoded with the target code length to thereby create the edited coded stream ST1.

A method for creating the edited coded stream ST1 by way of 2-pass encoding is described hereinafter in detail. The following description is directed to the embodiment in which the image encoding apparatus 1 edits an already stored title (original stream) by designating optional two pictures, for example, and makes the dubbing of the edited title.

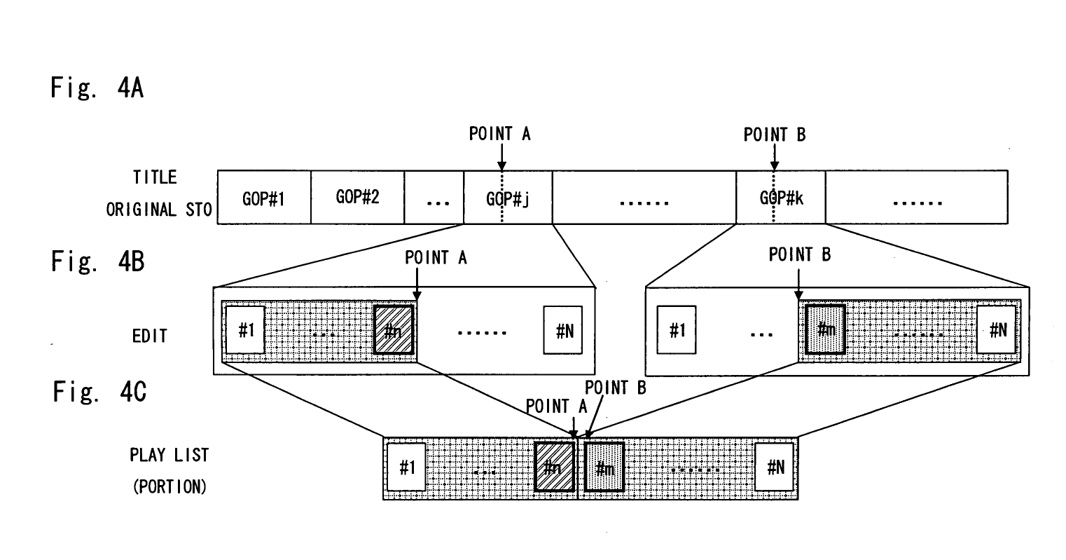

FIGS. 4A to 4c are views to describe a method of editing the original stream ST0. FIG. 4A shows an original stream, FIG. 4B shows GOP including an edit point which is extracted from the original stream, and FIG. 4C shows a part of an edited playlist.

As shown in FIG. 4A, the original stream ST0 is composed of a plurality of GOP #1, #2, . . . #j, . . . #k . . . . For simplification of description, in this embodiment, each GOP includes N number of pictures, where N is an integer, which are arranged in the same sequence (with the same coding rule) such as I, P, B, B, P . . . , for example. The present invention is applicable if the same frame is encoded into the same picture between the original stream ST0 and the edited coded stream ST1. Specifically, a GOP length, a coding rule or the like is not necessarily the same among all GOP as long as the picture phases are aligned between the original stream ST0 and the edited coded stream ST1.

It is assumed that the complexity of the pictures which constitute the original stream ST0 is analyzed by the analyzer 23 when the original stream ST0 is created from video data and stored as complexity X in the storage device 30.

The following description is directed to the case of creating the edited coded stream ST1 with the use of edit points A and B shown in FIG. 4A. In an exemplary case, the original stream ST0 has s(1≦s≦S) number of GOP, and each GOP #s has t(1≦t≦N) number of pictures. The edit point A indicates a point between the pictures #n(1≦n≦N) and #n+1 of GOP #j(1≦j≦S). If the picture #n=#N, the edit point A indicates a GOP boundary. The pictures subsequent to the edit point A are cut out. The edit point B indicates a point between the pictures #m−1 and #m(1≦m≦N) of GOP #k(1≦k≦S). If the picture #m=#1, the edit point B indicates a GOP boundary. The pictures previous to the edit point B are cut out.

For example, in a GOP unit, the stream from the head picture #1 to the picture #n immediately previous to the edit point A in GOP #j and the stream from the picture #m immediately subsequent to the edit point B to the final picture #N in GOP #k are extracted, and the two streams are edited such that the edit points A and B are arranged in succession as shown in FIG. 4C.

The editor 3 can edit an original stream (title) by designating optional two edit points A and B in the original stream. Specifically, it is possible to create the edit stream which terminates at the edit point A, the edit stream which starts at the edit point B, the edit stream in which the edit points A and B are played back in succession, and so on. In the editing procedure, a play list to serve as a virtual title is created regardless of whether or not any alternation is made to the original stream. The original stream may be edited when creating a playlist. The editor 3 supplies the stream in units of GOP to the decoding processor 4 which is a MPEG AV decoder by referring to the created playlist, thereby allowing continuous playback of the edit points A and B, for example.

The audio and video signals output from the decoding processor 4 are input to the display 5, thereby playing back the edited stream. At the same time, the edited stream decoded by the decoding processor 4 is input to the encoding processor 2, so that the complexity of the original stream can be referred to in the encoding procedure, thereby implementing the 2-pass encoding. The result is then supplied to the storage device 40, thereby enabling recording (dubbing) of the edited original stream which is edited from the original stream using the 2-pass encoding.

The 2-pass encoding can be implemented provided that a picture type (picture phase) of each frame present in the 2nd-pass encoding is the same as that in the 1st-pass encoding. Because a code length is allocated in accordance with the complexity obtained by the analysis in the 1st pass, it is unable to allocate an appropriate code length if picture phases are different.

Therefore, the rule of a picture composition in each GOP and the GOP length (a total number of pictures per GOP), which are referred to herein as a picture composition, of the edited coded stream ST1 created by the encoding processor 2 should be the same as those in the 1st-pass encoding. In other words, it is necessary to align the picture phase of the edited coded stream ST1 with the picture phase of the original stream ST0.

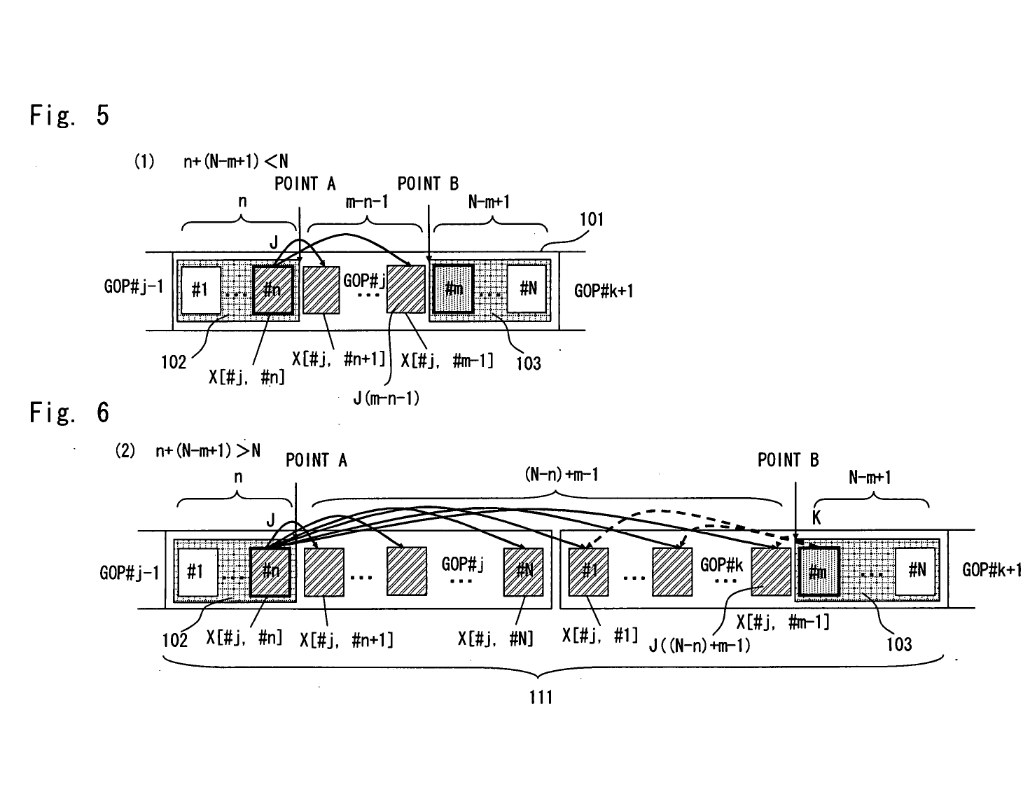

FIGS. 5 to 10 are views to describe a method of creating an edited stream. The editor 3 controls the operation of the decoding processor 4 and the encoding processor 2 in each of the six patterns as illustrated in FIGS. 5 to 10. FIGS. 5 to 8 illustrate the cases where the two edit points A and B are bonded together. As shown in FIGS. 5 and 6, if a total number of pictures (n+(N−m+1)) consisting the picture group (referred to herein as an edited picture group) which contains the pictures #1 to #n of GOP #j and the pictures #m to #N of GOP #k is different from an integral multiple of N, one or more predetermined images (insertion images) are inserted between the edit points A and B so that a total number of pictures consisting a picture group (re-coded picture group) which is obtained by encoding the edited picture group with the insertion image(s) reaches an integral multiple of N.

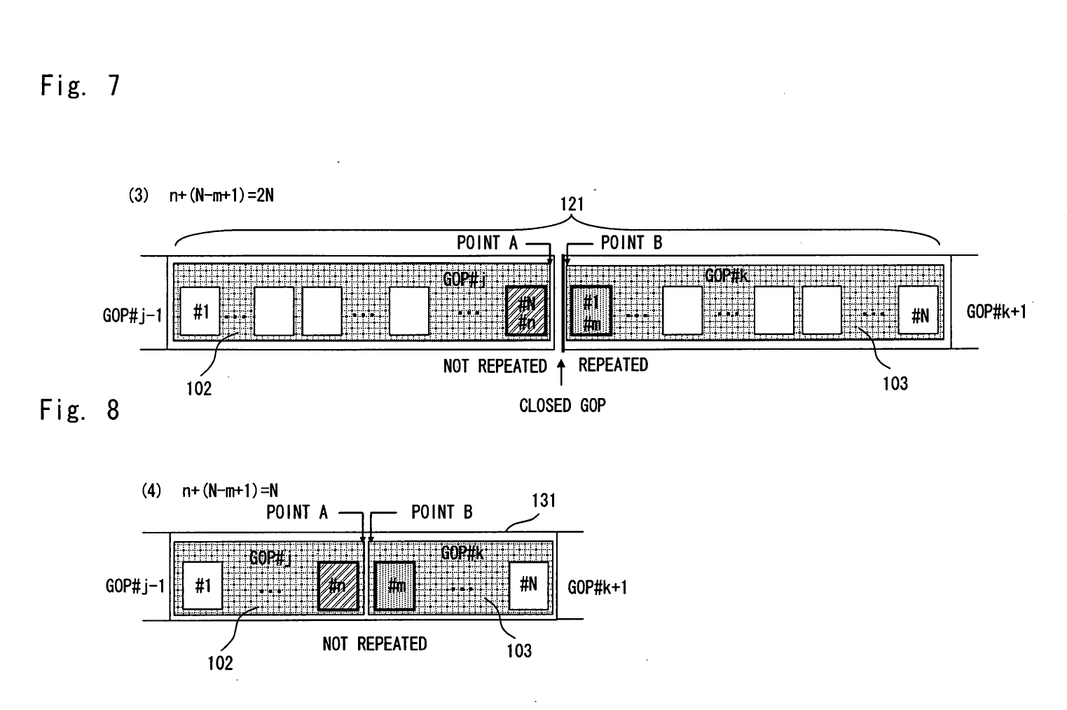

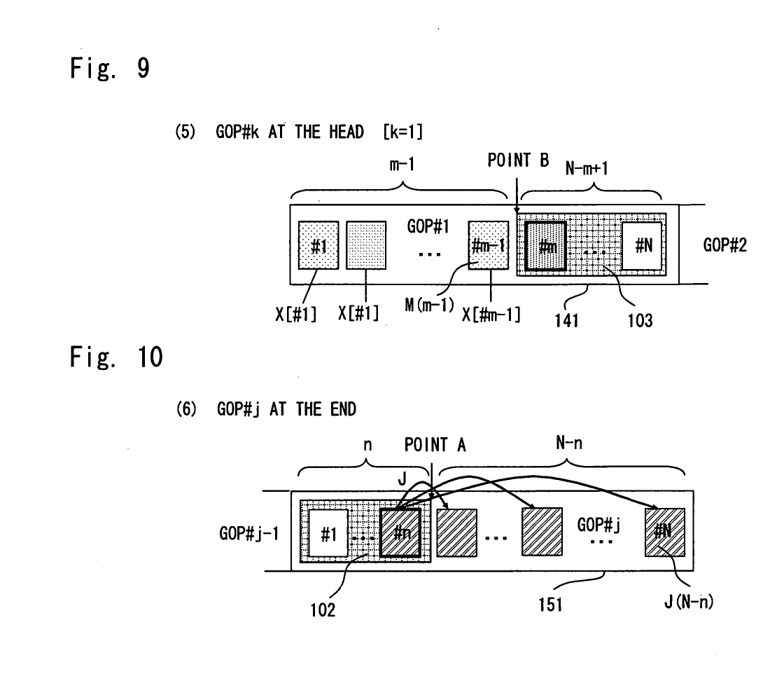

FIGS. 7 and 8 illustrate the cases where a total number of pictures consisting an edited picture group is N or 2N. In such a case, the edit point B corresponds with a GOP boundary in the edited coded stream ST1, and there is thus no need to insert any insertion image. FIGS. 9 and 10 illustrate the cases where there is a single edit point and when the edit point B comes at the head of the edited stream and when the edited stream ends with the edit point A, respectively. Those six patterns of editing methods may be used alone or in combination to create an edited stream.

First, the case where a total number of pictures consisting an edited picture group does not reach an integral multiple of N is described.

(1) n+(N−m+1)<N (cf. FIG. 5)

Referring to FIG. 5, a total number of pictures consisting an edited picture group being n+(N−m+1)<N means that a sum n+(N−m+1) of the number of pictures n constituting a GOP #j portion 102 composed of the pictures from the head picture #1 to the picture #n immediately previous to the edit point A in the GOP #j, and the number of pictures (N−m+1) constituting a GOP #k portion 103 composed of the pictures from the picture #m immediately subsequent to the edit point B to the final picture #N in the GOP #k, is less than N.

In such a case, the editor 3 controls the encoding processor 2 to insert the (m−n−1) number of first decoded images J which are decoded from the picture #n in the GOP #j between the edit points A and B in the GOP #j and create a re-coded picture group 101. As a result of inserting the (m−n−1) number of decoded images J between the edit points A and B of the edited picture group, the number of pictures of the re-coded picture group reaches N. This allows the re-coded picture group 101 to have the same number of pictures as other GOP.

Inserting the (m−n−1) number of decoded images J enables the GOP #j portion 102 and the GOP #k portion 103 to have the same picture phases as the GOP #j and the GOP #k, respectively. It is thereby possible to refer to the complexity X of the GOP #j and the GOP #k for the GOP #j portion 102 and the GOP #k portion 103 respectively having the same picture phases.

An insertion picture (first insertion picture) which is obtained as a result of encoding the decoded image J does not exist in the original stream ST0, and the complexity of the first insertion picture is thus not yet analyzed. However, the decoded image J is obtained by decoding the picture #n of the GOP #j, and the complexity when creating the picture #n of the GOP #j from the image J is already obtained by pre-analysis. Thus, in this embodiment, the complexity of the insertion picture which is created from the decoded image J is calculated based on the complexity which is pre-analyzed when creating the picture #n of the GOP #j. The complexity in creating each picture of the edited stream can be thereby obtained by reference or calculation, which allows allocating an optimum code length when creating the edited stream, thus enabling appropriate 2-pass encoding. A calculation method for complexity of an insertion picture created from a decoded image J and an encoding process using the complexity are described in detail later.

(2) n+(N−m+1)>N (cf. FIG. 6)

Referring to FIG. 6, a total number of pictures consisting an edited picture group being n+(N−m+1)>N means that a sum n+(N−m+1) of the number of pictures n constituting a GOP #j portion 102 composed of the pictures from the head picture #1 to the picture #n immediately previous to the edit point A in the GOP #j, and the number of pictures (N−m+1) constituting a GOP #k portion 103 composed the pictures from the picture #m immediately subsequent to the edit point B to the final picture #N in the GOP #k, is greater than N.

In such a case, the editor 3 controls the encoding processor 2 to insert the ((N−m)+(m−1)) number of decoded images J which are decoded from the picture #n in the GOP #j between the edit points A and B in the GOP #j and create a re-coded picture group 111. As a result of inserting the ((N−m)+(m−1)) number of decoded images J decoded from the picture #n in the GOP #j between the edit points A and B of the edited picture group, the number of pictures of the re-coded picture group reaches 2N.

Inserting the ((N−m)+(m−1)) number of decoded images J enables the GOP #j portion 102 and the GOP #k portion 103 to have the same picture phases as the GOP #j and the GOP #k, respectively. It is thereby possible to refer to the complexity X of the GOP #j and the GOP #k for the GOP #j portion 102 and the GOP #k portion 103 respectively having the same picture phases. The complexity of the insertion picture may be calculated from the complexity of the picture #n in the GOP #j as described above.

Though the case of inserting the decoded image J decoded from the picture #n in the GOP #j is described above, it is possible to use not only the decoded image J but also a decoded image K decoded from the picture #m in the GOP #k. Specifically, the insertion image J is inserted into the GOP #j portion 102 as a first insertion image so that the number of frames becomes N. Then, the insertion image K is inserted as a second insertion image so that the number of frames becomes N inclusive of the insertion image K and the GOP #k portion 103. A total number of pictures of the re-coded picture group thereby reaches 2N. In such a case, the video obtained by decoding the pictures between the edit points A and B are still images of the decoded images J and K, which produces more natural edit results compared with the case of using the decoded image J alone.

(3) n+(N−m+1)=2N (cf. FIG. 7)

Referring to FIG. 7, a total number of pictures consisting an edited picture group being (n+(N−m+1))=2N means that a sum n+(N−m+1) of the number of pictures n constituting a GOP #j portion 102 composed of the pictures from the head picture #1 to the picture #n immediately previous to the edit point A in the GOP #j, and the number of pictures (N−m+1) constituting a GOP #k portion 103 composed of the pictures from the picture #m immediately subsequent to the edit point B to the final picture #N in the GOP #k, equals 2N.

This is the case where the picture #n =the picture #N in the GOP #j, the picture #m=the picture #1 in the GOP #k, the GOP #j portion 102 corresponds to the whole part of the GOP #j, the GOP #k portion 103 corresponds the whole part of the GOP #k, and a re-coded picture group (=edited picture group) 121 after editing to bond the edit points A and B has the same phase as the GOP in the 1st pass. In such a case, the 2nd-pass encoding can be performed using the complexity of GOP without inserting any insertion image, unlike the above cases (1) and (2). The GOP #k portion 103=GOP #k can be a closed GOP.

(4) n+(N−m+1)=N (cf. FIG. 8)

Referring to FIG. 8, a total number of pictures consisting an edited picture group being (n+(N−m+1))=2N means that a sum n+(N−m+1) of the number of pictures n constituting a GOP #j portion 102 composed of the pictures from the head picture #1 to the picture #n immediately previous to the edit point A in the GOP #j, and the number of pictures (N−m+1) constituting a GOP #k portion 103 composed of the pictures from the picture #m immediately subsequent to the edit point B to the final picture #N in the GOP #k, equals N.

In this case as well, a re-coded picture group (=edited picture group) 131 after editing to bond the edit points A and B has the same phase as the GOP. Thus, the 2nd-pass encoding can be performed without inserting any insertion image just like the above case (3).

(5) GOP #k Existing at the Head (cf. FIG. 9)

Referring to FIG. 9, this is the case where an edited stream ranges from the edit point B to the final picture of the original stream as shown in FIG. 4A, for example, which is, GOP #k=GOP #1.

In such a case, an edited picture group includes a GOP #k portion 103 which contains the pictures from the picture #m immediately subsequent to the edit point B to the final picture #N in the GOP #k. However, if the edited picture group is used as a head GOP as it is, the picture #m of the GOP #k is encoded into an I-picture, which causes unalignment of the picture phases in the 2nd-pass encoding, making it unable to use the complexity of the original stream as a reference. To avoid this, the (m−1) number of insertion images are inserted in the position previous to the GOP #k portion 103 to create a re-coded picture group 141 so that the number of pictures reaches N. The insertion images (third insertion images) which are inserted for phase alignment may be predetermined monochromatic images M1 to M(m−1). It is also possible to use a decoded image K which is decoded from the picture #m of the GOP #k as an insertion image, for example. Inserting monochromatic images for phase alignment enables suppression of an increase in a code length, and a predetermined complexity for the monochromatic images can be used.

An insertion picture which is obtained by encoding the insertion image also does not exist in the original stream, and its complexity is not analyzed. However, when a monochromatic image is encoded into an insertion picture, a necessary code length is very small, and a value of the complexity can be set appropriately. If a decoded image K is used as the insertion image, the complexity may be calculated from the complexity when creating the picture #m of the GOP #k as described above.

(6) GOP #j Existing at the End (cf. FIG. 10)

Referring to FIG. 10, this is the case where an edited stream ranges from the head picture of the original stream to the edit point A as shown in FIG. 4A, for example, which is, GOP #j=GOP #S.

In such a case, an edited picture group includes a GOP #j portion 102 which contains the pictures from the head picture #1 to the picture #n immediately previous to the edit point A in the GOP #j. The number of pictures is n. The (N−n) number of images J which are decoded from the picture #n of the GOP #j are inserted as fourth insertion images in the position subsequent to the GOP #j portion 102 to create a re-coded picture group 151, so that so that the total number of pictures reaches N and GOP lengths are aligned.

However, if the GOP #j is a final GOP, it is possible to align the picture phase without inserting the (N−n) number of insertion images and refer to the complexity in the 1st pass in the 2nd-pass encoding. Specifically, if the picture #n is the picture #1 and an I-picture, it is able to refer to the complexity of the original stream ST0 for the complexity up to the edit point A without inserting any insertion images, thus enabling 2-pass encoding. If the picture #n is a P-picture or a B-picture, a minimum number of insertion images which is required for decoding the picture #n may be inserted to enable 2-pass encoding. In such a case, it is able to refer to the complexity of the original stream ST0 for the complexity up to the edit point A and calculate the complexity of the insertion picture from the complexity of the picture #n in the GOP #j.

As described above, even after making an edit in some part of GOP constituting an original stream, decoding after the editing, and re-encoding to create a coded stream, the frame which is the same as in the original stream can have the same picture type, with aligned picture phases. The edited stream is therefore encoded into the same picture type as the original stream, and no deterioration of image quality occurs. Further, if complexity is analyzed when creating an original stream, the analyzed complexity can be referred to when creating an edited coded stream, which enables 2-pass encoding with an optimum code length allocated in accordance with the complexity.

In the foregoing description, a total number of pictures constituting the re-coded picture group 101, 131, 141 or 151 is N in the above cases (1), (4), (5) and (6), and a total number of pictures constituting the re-coded picture group 111 or 121 is 2N in the above cases (2) and (3). However, a total number of pictures constituting a re-coded picture group is not limited thereto. As long as a total number of pictures constituting a re-coded picture group is an integral multiple of N, the picture phases can be aligned regarding the edit point A in the edited coded stream ST1 by setting the frame in the previous or subsequent position of the edit point in the edited coded stream ST1 to have the same picture type as that in the original stream ST0.

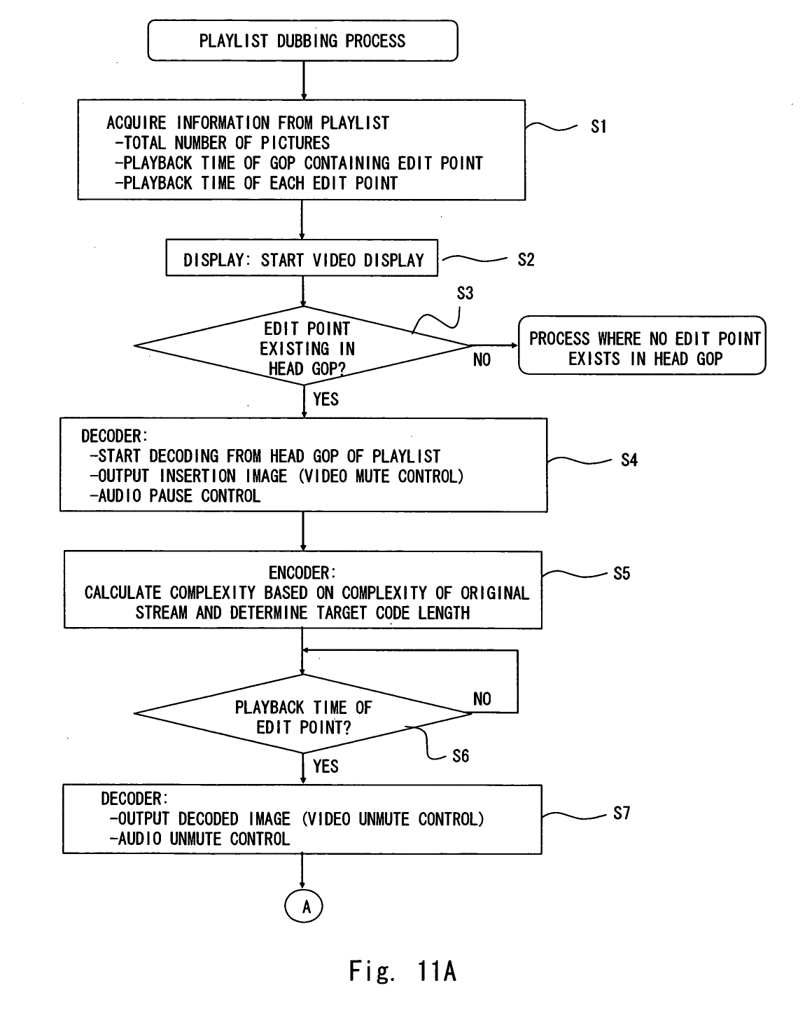

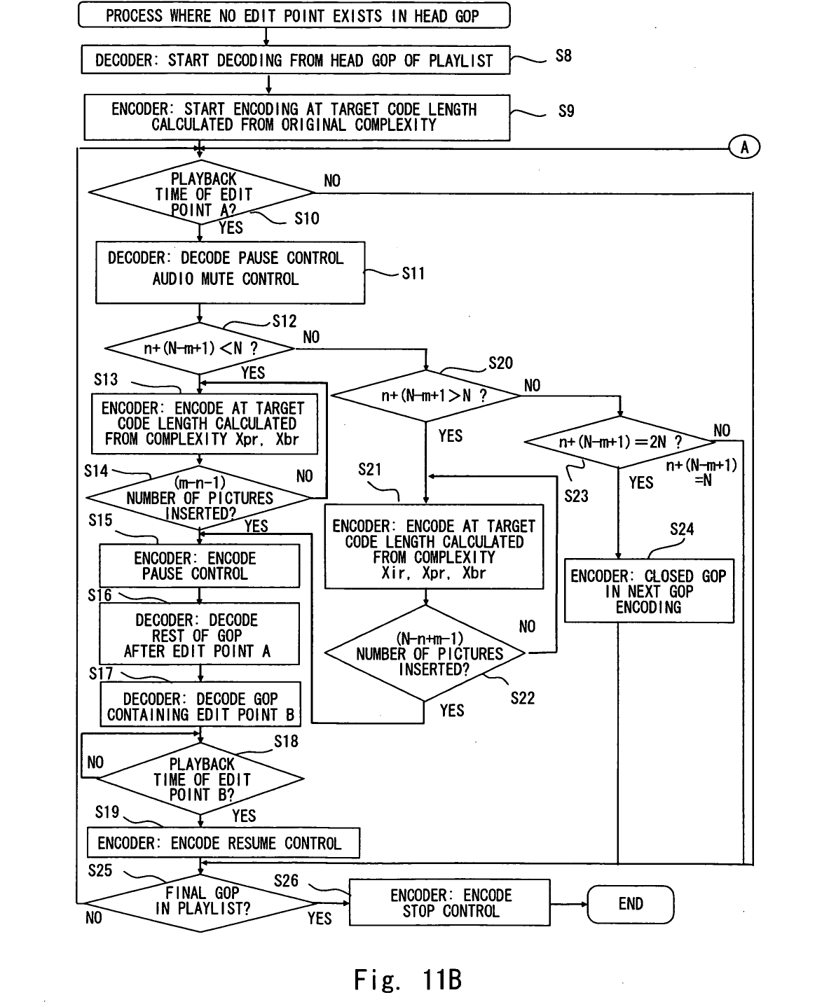

A 2-pass encoding method according to this embodiment is described hereinafter in detail. FIGS. 11A and 11B are flowcharts showing the encoding process on the 2nd pass. It is assumed that the storage device 30 which is connected to the image encoding apparatus 1 stores an original stream for which complexity is already analyzed. A user creates a playlist by editing the title, which is then stored in the storage device 40 using the 2-pass encoding.

Although the following description is directed to the case of both playing back the edited title on the display 5 and re-encoding the edited title then storing it in the storage device 40, it is possible to store the edited title without playing back on the display 5. The description is given on the case where the original stream ST0 stored in the storage device 30 is an original coded stream on the 1st pass, and the edited coded stream ST1 to be stored in the storage device 40 is an edited MPEG-coded stream which is encoded by the 2-pass encoding.

As shown in FIG. 11A, the image encoding apparatus 1 first acquires, from an edited playlist, information on a total number of pictures, a playback time of GOP including an edit point, and a playback time of each edit point (Step S1). After acquiring those information, the display 5 displays an edited original stream (title) (Step S2). Then, the editor S3 determines to which case of (1) to (6) the edit point applies, and, in accordance with the determination result, controls the operation of the decoding processor 4 and the encoding processor 2 to implement 2-pass encoding. Firstly, it is determined whether an edit point exists in the head GOP of the playlist (Step S3). If there is no edit point in the head GOP, the process proceeds to the processing shown in FIG. 11B as described later.

On the other hand, if there is an edit point in the head GOP, the editor 3 performs the following process. In this example, the description is given on the case (5) shown in FIG. 9, where the edit point B exists in the head GOP. In such a case, the decoding processor 4, under control of the editor 3, starts decoding procedure from the head GOP but does not output GOP until a playback time of the edit point B is reached. During this period, the display 5 displays an insertion image such as a preset monochromatic image in place of image playback (insertion image output (video mute control)), and performs muting in place of audio playback (audio mute control) (Step S4). The encoding processor 2 implements 2-pass encoding on the insertion image such as a monochromatic image output from the decoding processor 4 by controlling a code length in accordance with complexity.

Until reaching the edit point B being processed, the insertion image output from the decoding processor 4 is encoded into a picture of a prescribed type. Most preferably, encoding may be performed so that the picture composition is the same as that of GOP in the original stream. However, because the phases of the pictures subsequent to the edit point B can be aligned by inserting the (N−m) number of insertion images, the picture type encoded from the insertion image may be different from the picture composition of GOP in the original stream. Because the insertion image does not exist in the original stream ST0, the complexity of the insertion image is not yet obtained.

In this embodiment, the complexity calculator 52 calculates the complexity of the insertion image as needed. For example, the complexity of the insertion image may be calculated based on the corresponding complexity of the head GOP in the original stream. If the insertion image is a monochromatic image, a required code length is very small and predetermined complexity or the like may be used. Because the insertion image which is arranged at the head is decoded into an I-picture, the complexity of the insertion image may equal to or a fraction of the complexity of the head picture of the head GOP of the original stream. The code length allocator 24 retrieves the complexity and determines a target code length in accordance with the complexity. The encoding processor 2 thereby sequentially encodes the insertion image to have the same picture phase as GOP (Step S5).

Upon reaching the playback time of the edit point B (Yes in Step S6), the decoding processor 4 outputs a decoding result of the picture #m and subsequent pictures in the GOP#k (decoded image output (video unmute)/audio unmute control) (Step S7). The encoding processor 2 thereby receives decoded data of the original stream and encodes them after reaching the edit point B. Because the pictures subsequent to the edit point B have the same picture phase as the corresponding pictures in the original stream, the complexity calculator 52 reads out the complexity of the original stream stored in the storage device 30, and the code length allocator 24 determines a target code length in accordance with the complexity, so that the encoder 21 MPEG-encodes the decoded data with the target code length. The process then proceeds to Step 10 described later.

If it is determined in Step S3 that there is no edit point in the head GOP, the process proceeds to Step S8 in FIG. 11B. If no edit point exists in the head GOP in the playlist, the decoding processor 4 starts decoding from the head GOP. Then, in the encoding processor 2, the complexity calculator 52 reads out the complexity of each picture of the corresponding GOP in the original stream, the code length allocator 24 calculates and allocates a target code length, and the encoder 21 MPEG-encodes the decoded data output from the decoding processor 4 with the target code length (Step S9).

In this manner, the encoding processor 2 implements the 2-pass encoding that encodes the image decoded by the decoding processor 4 with an appropriate code length controlled in accordance with the complexity until reaching a playback time of the edit point A. Upon reaching the playback time of the edit point A (Yes in Step S10), the decoding processor 4 pauses the output by way of repeatedly decoding the decoded image J of the picture #n of the GOP#j which is decoded immediately previously or the like (decode pause control). During this period, the audio is muted (audio mute control) (Step S11).

Then, if a total number of pictures (n+(N−m+1)) constituting the edited picture group which includes the edit point A and the edit point B which is bonded to the edit point A is smaller than N, (Yes in Step S12), which is in the case (1) shown in FIG. 5, the (m−n−1) number of decoded images J are encoded. In the encoding processor 2, the complexity calculator 52 calculates complexity Xpr and Xbr as described later, the code length allocator 24 calculates a target code length from the complexity Xpr and Xbr, and the encoder 21 implements encoding such that the target code length is reached (Step S13).

After the encoder 21 encodes the (m−n−1) number of decoded images J, i.e. inserts the (m−n−1) number of insertion pictures encoded from the image J (Yes in Step S14), the editor 3 controls the encoder 21 to pause the encoding procedure (encode pause control) (Step S15). The editor 3 inserts between the edit points A and B the (m−n−1) number of insertion pictures which are encoded from the image J decoded from the picture #n of the GOP#j so that a total number of pictures constituting the re-coded picture group reaches N. The phase of the pictures previous to the edit point A and the pictures subsequent to the edit point A in the re-coded picture group can be thereby aligned with the phase of the pictures in the original stream.

After that, the editor 3 releases the decode pause control and the audio mute control in the decoding processor 4 so that the remaining part of the GOP #j subsequent to the edit point A is decoded (Step S16). After the decoding processor 4 completes decoding of the GOP #j, the editor 3 supplies the GOP #k which includes the edit point B arranged in succession to the edit point A to the decoding processor 4. The decoding processor 4 then decodes the GOP #k including the edit point B (Step S17). Upon reaching the playback time of the edit point B (Yes in Step S18), the editor 3 controls the encoding processor 2 to release the encode pause control (encode resume control). The encoder 21 thereby starts encoding the decoded image data in the subsequent part of the edit point B (Step S19).

If a total number of pictures (n+(N−m+1)) constituting the edited picture group is greater than N, (No in Step S12 and Yes in Step S20), which is in the case (2) shown in FIG. 6, the complexity calculator 52 in the encoding processor 2 calculates complexity Xir, Xpr and Xbr as described later, the code length allocator 24 calculates a target code length from the complexity Xir, Xpr and Xbr, and the encoding processor 2 implements encoding such that the target code length is reached (Step S21).

After the encoding processor 2 encodes the (N−n+m−1) number of decoded images J, i.e. inserts the (N−n+m−1) number of insertion pictures encoded from the image J (Yes in Step S22), the process from Step S15 described above is performed. Specifically, the editor 3 makes the encode pause control of the encoding processor 2, causes the decoding processor 4 to decode the remaining part of the GOP #j and further start decoding from the head picture of GOP #k, and executes the encode resume control of the encoding processor 2 at the playback time of the edit point B (Steps S15 to S19). As described earlier, it is feasible to insert the (N−n) number of pictures encoded from the decoded image J and insert the (m−1) number of pictures encoded from the decoded image K.

If a total number of pictures (n+(N−m+1)) constituting the edited picture group is 2N, (No in Step S20 and Yes in Step S23), which is in the case (3) shown in FIG. 7, or if a total number of pictures (n+(N−m+1)) constituting the edited picture group is N, (No in Step S23), which is in the case (4) shown in FIG. 8, the process proceeds to Step S25. If the total number of pictures (n+(N−m+1)) is 2N (Yes in Step S23), the editor 3 may instruct the encoding processor 2 so that the GOP #k including the edit point B becomes a closed GOP.

As described in the foregoing, the editor 3 appropriately controls the operation of the decoding processor 4 and the encoding processor 2 in accordance with the total number of pictures (n+(N−m+1)) constituting the edited picture group to be 2-pass encoded. If there is no edit point, the decoding processor 4 decodes the GOP indicated by the playlist supplied from the editor 3, and the encoding processor 2 sequentially MPEG-encodes the decoded image. After the decoding processor 4 decodes the final GOP in the playlist and the encoding processor 2 encodes it (Yes in Step S25), the editor 3 terminates the encoding in the encoding processor 2 (Step S26).

This embodiment inserts a picture encoded from a monochromatic image or a decoded image decoded from a picture immediately previous or subsequent to an edit point, thereby allowing the phase of the pictures previous to the edit point A and/or subsequent to the edit point B to be aligned with the phase of the pictures of the original stream. This enables 2-pass encoding by referring to the complexity which is analyzed when encoding the original stream and setting an appropriate target code length.

In order to enable the 2-pass encoding, the process pause-controls the decoding processor 4 and inserts one or more decoded images J shown in FIG. 5, for example, to align picture phases. Because the pictures encoded from the insertion images (decoded images J, K, monochromatic image etc.) do not exist in the original stream, the complexity cannot be referred therefrom. Thus, this embodiment estimates the complexity of the insertion image from the complexity of the original coded stream.

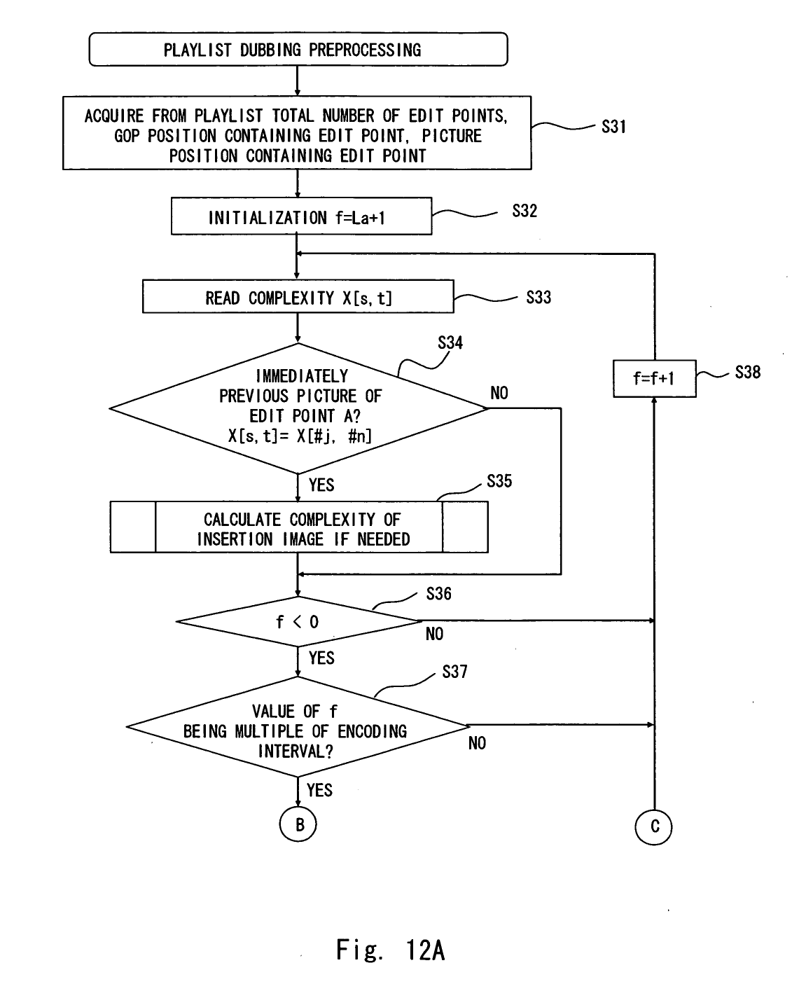

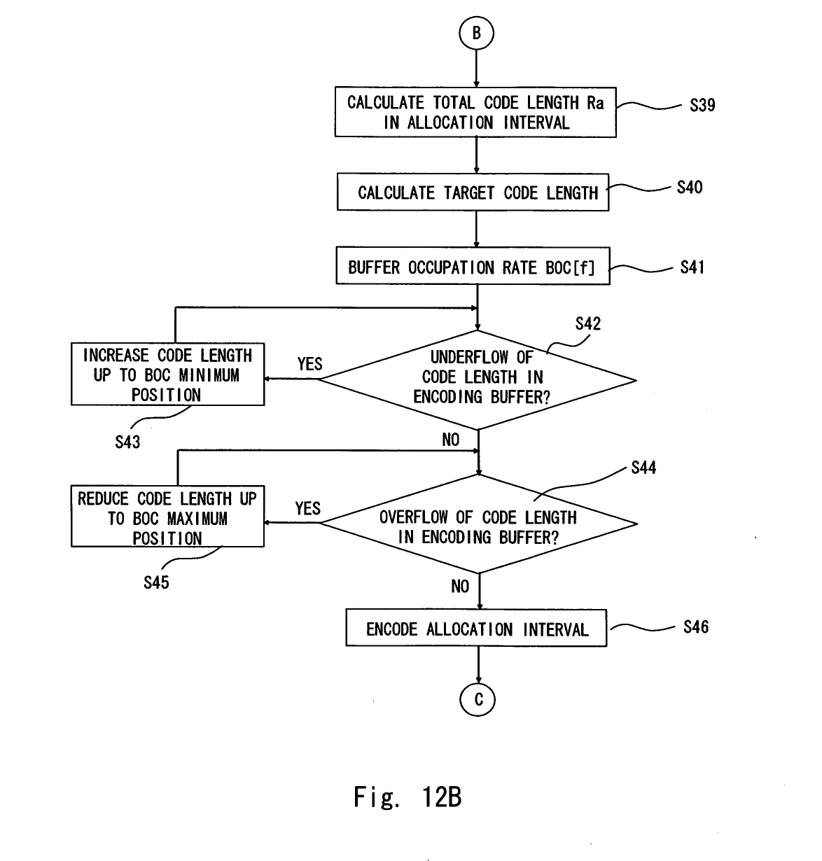

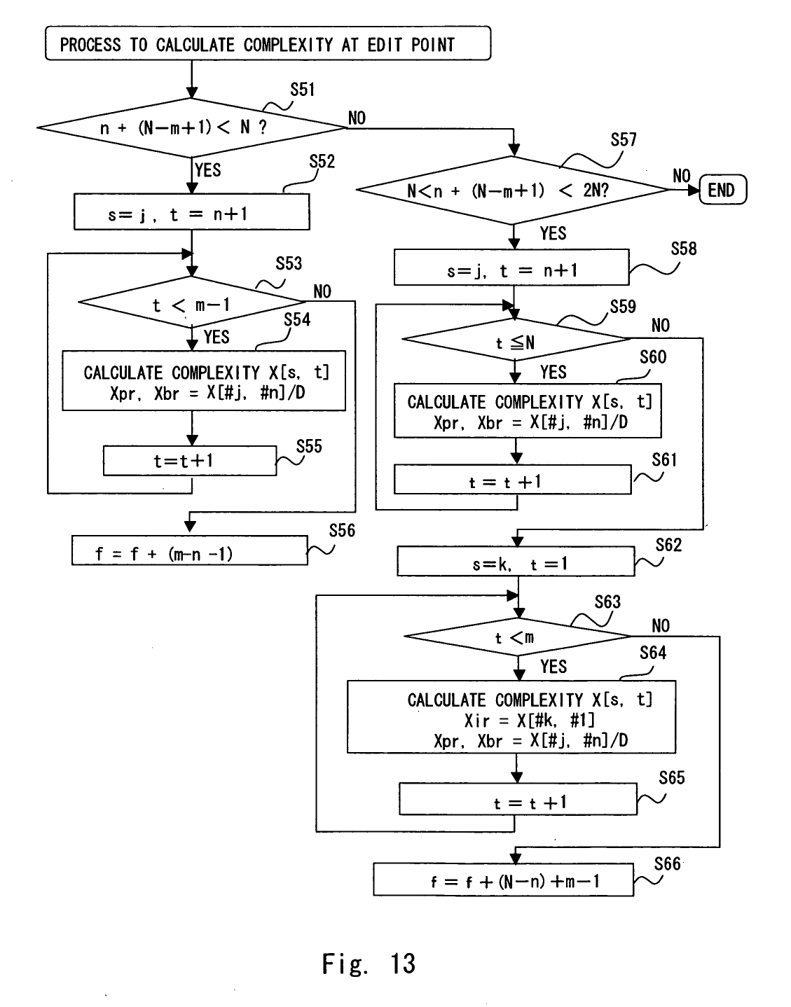

A method for calculating a target code length in the code length allocator 24 of the encoding processor 2 and a method for calculating complexity when encoding an insertion image which does not exist in an original stream are described hereinafter. FIGS. 12A and 12B are flowchart showing a process of calculating a target code length using complexity, and FIG. 13 is a flowchart showing a process of calculating complexity of an insertion picture.

The number of frames for which an input decoded image can be analyzed by the encoding of a frame f is La. As shown in FIG. 12A, the complexity calculator 52 first acquires from a playlist a total number of edit points, a GOP position containing an edit point, and, a picture position of an edit point (Step S31). The code length allocator 24 initializes the frame number f of the input decoded image to −La+1 (Step S32).

Then, the complexity calculator 52 reads complexity X[s,t] of GOP sequentially along the playlist (Step S33). The complexity of the original stream ST0 is analyzed beforehand and stored together with the original stream ST0, for example. The complexity X[s,t] indicates the complexity of the picture #t (1≦t≦N) of the GOP #s (1≦s≦S) in the original stream ST0.

After reading of the complexity X[s,t]=X[#j, #n] of the picture immediately previous to the edit point A is completed (Yes in Step S34), this embodiment inserts an insertion image for aligning phases into the subsequent position according to need. Thus, the complexity of the insertion image to be inserted between the edit points is calculated (Step S35). A detail of this step is detailed later with reference to FIG. 13.

The complexity calculator 52 then determines whether the input frame f satisfies the number of frames La (Step S36). If the number of frames of the input image is less than the number of frames La, which is when the frame number f of the image which is initialized to −La+1 is f<0, the complexity calculator 52 increments the value of f (Step S38) and reads the complexity of the next image.

If, on the other hand, the number of frames of the input image equals the number of frames La (j=0), the complexity calculator 52 determines whether the frame f is a multiple of a unit interval C for encoding (Step S37).

If the frame number f is not a multiple of a unit interval C for encoding, the complexity calculator 52 increments the value of f (Step S38) and reads the complexity of the next image.

On the other hand, if the frame number f is an integral multiple of a unit interval C for encoding, the code length allocator 24 allocates a code length to the code length allocation interval C.

Firstly, a total code length Ra in an allocation interval is calculated based on a bit rate of the 2nd-pass encoding. The total code length may be adjusted in consideration of a buffer occupation rate BOC[f] (Step S39.)

Then, the code length allocator 24 calculates a target code length of each frame. The target code length T[f] of each frame can be calculated by allocating Ra[f] which can be allocated to a code length allocation interval in proportion to complexity X[s,t], which is expressed as:
T[f]=(X[s,t]/Xsum)*Ra[f]
where Xsum is a total of complexity X[s,t] in an allocation interval. The target code length T[f] is calculated for each frame from the frame f to the frame f+L−1 (Step S41).

After that, the code length allocator 24 calculates a buffer occupation rate of the allocated target code length in the encoding buffer 22 (Step S41). For example, the buffer occupation rate BOC[f] can be calculated as:
BOC[f]=BOC[f−1]+T[f]−Rframe
where Rframe is a code length per frame which is calculated from the bit rate R used in the encoding of this embodiment. An initial value of the buffer occupation rate is BOC[0]=0.

The code length allocator 24 then determines whether overflow or underflow occurs in the encoding buffer 22 based on the calculated buffer occupation rate BOC[f]. For example, if an upper limit of the encoding buffer 22 is B, it is determined whether the buffer occupation rate BOC[j] is smaller than B−Rframe

If underflow occurs in the encoding buffer 22 (Yes in Step S42), the code length allocator 24 adjusts a code length in order to prevent the underflow from occurring in the encoding buffer 22 (Step S43). For example, it detects a frame fu with which the occupation rate of the code length in the encoding buffer 22 is the lowest, and increases the code length allocated the frames f to fu in such a way that underflow does not occur in the encoding buffer 22 with the frame fu. Then, the code length allocated to the frames fu+1 to f+L−1 is reduced by the amount corresponding to the increment of the code length.

If, on the other hand, overflow occurs in the encoding buffer 22 (Yes in Step S44), the code length allocator 24 adjusts a code length in order to prevent the overflow from occurring in the encoding buffer 22. For example, it detects a frame fo with which the occupation rate of the code length in the encoding buffer 22 is the greatest, and reduces the code length allocated to the frames f to fo in such a way that overflow does not occur in the encoding buffer 22 with the frame fo. Then, the code length corresponding to the decrement is allocated to the frames fo+1 to f+L−1 (Step S45).

If an appropriate allocation with which overflow or underflow does not occur in the encoding buffer 22 is provided (No in Step S42, No in Step S44), the encoder 21 performs encoding on the allocation interval C (Step S46). The process then proceeds to Step S38 to increment the value of the frame f (Step S38), and the complexity calculator 52 reads the complexity of the next image and repeats the above process.

A process for calculating the complexity of the insertion image J is described hereinafter. Referring to FIG. 13, it is determined firstly whether a total number n+(N−m+1) of the pictures consisting the re-coded picture group is smaller than N or not (Step S51). If the total number is smaller than N, it is set such that s=j and t=n+1 (Step S52) and, until reaching t=m−1 (Step S53), the complexity X[s,t] is calculated sequentially (Step S54).

While t is t=n to m−1, the process for encoding the same decoded image J is performed. In such a case, the decoded image J is displayed in pause at the edit point A as described above, and a new image which does not exist in the original stream in the 1st pass encoding is inserted for encoding the decoded image J. The complexity of this insertion image is not obtained in the 1st-pass encoding procedure. Thus, a target code length per picture cannot be calculated as it is.

The insertion image is a decoded image J with t=n. In this embodiment, the calculation is performed in accordance with the picture type into which the decoded image J is encoded, using the complexity X[#j, #n] of the decoded image J. If the decoded image J is encoded into a P-picture, the complexity used for calculation is:
complexity Xpr=X[#j, #n]/Dp
If the decoded image J is encoded into a B-picture, the complexity used for calculation is:
complexity Xbr=X[#j, #n]/Dp

The values of Dp and Db are 0<Dp≦Db, and they may be set such that: Xpr=X[#j, #n]/3 and Xbr=X[#j, #n]/10, for example. If there is repetition of the same picture in the 1st pass encoding, Dp and Db may be determined in reference to its complexity. The (m−n−1) number of insertion pictures are inserted in order to align the phases of the pictures subsequent to the edit point B, and the (m−n−1) number of pictures do not necessarily have the same picture type as the pictures t=n+1 to m−1 in the original stream. If it is necessary to increase the code length allocated to the portion previous to the edit point A or subsequent to the edit point B, it is possible to increase the number of B-pictures compared with the original stream to thereby reduce the complexity of the insertion picture.

Though the insertion image is described as the decoded image J with t=n, the insertion image may be a decoded image K with s=k and t=m. It is thus possible to calculate the complexity of the insertion image in the same way as above based on the complexity X[#k, #m] of the decoded image K which is decoded from the picture #m of the GOP #k.

It is also possible to adjust the value of Dp and Db in accordance with the picture type of the decoded image J or K in the original stream. For example, Dp and Db may be set larger if the decoded image J or K is an I-picture in the original stream ST0, and Dp and Db may be set relatively smaller if the decoded image J or K is an B-picture in the original stream ST0. Specifically, though Dp=3 and Db=10 in the above example, it may be set such that Dp=⅓ and Db=1 in accordance with the picture type or the like of the decoded image J or K, so that the complexity is equal to or greater than the complexity when encoding the decoded image J or K.

Then, the value of t is sequentially incremented (Step S55), and upon reaching t=m, the frame number f is increased by the total number of insertion pictures (m−n−1), i.e. the number of frames of the insertion picture, so that the frame f=f+(m−n−1) (Step S56). The process then proceeds to Step S36 in FIG. 12A.

If a total number of pictures n+(N−m+1) consisting a re-coded picture group is greater than N and smaller than 2N (Step S57), the values are set such that s=j and t=n+1 (Step S58), and until reaching t=N (Step S59), the complexity Xpr and Xbr are calculated as incrementing the value of t in the same way as Step S54 described above (Steps S60 and S61).

Upon exceeding t=N, the values are set such that s=k and t=1 (Step S62), and until reaching t=m (Step S63), the complexity X[s,t] is calculated as incrementing the value of t (Steps S64 and S65). Because the picture arranged in s=k and t=1 is the head picture of GOP, it is an I-picture. Though the I-picture is a still image of the decoded image J, because of being an I-picture, it is necessary to allocate a larger code length compared with P- or B- pictures. Thus, the complexity X[#k, #1] of the image with s=k, t=1 to be an I-picture can refer to the complexity X[#k, #1] of the original stream ST0 as it is. The P-picture and the B-picture after t=1 can be calculated with the complexity Xpr=X[#j, #n]/Dp and Xbr=X[#j, #n]/Dp in the same way. Upon reaching t=m, the frame number f is increased by the total number of insertion pictures (N−n)+m−1, i.e. the number of frames of the insertion picture, so that the frame f=f+(N−n)+m−1 (Step S66) The process then proceeds to Step S36 in FIG. 12A.

The timing for the processes of FIGS. 12A, 12B and 13 may be determined so that a target code length can be calculated prior to encoding each frame (decoded image) in the process of the 2-pass encoding performed in the encoding processor 2 as shown in FIGS. 11A and 11B.

This embodiment enables the phase of the pictures previous and subsequent to the edit point to be aligned with the picture phase of the original stream ST0 in an edited title (playlist) which is edited in units of frames (pictures) from the original stream. It is thereby possible to minimize the deterioration of image quality even after re-encoding with a lower bit rate. Further, if the complexity is analyzed and calculated when encoding the original stream, it is possible to refer to the complexity and calculate a target code length based on the complexity to thereby create an edited coded stream ST1 by 2-pass encoding. This enables creation of an edited coded stream ST1 for recording (dubbing) into DVD or the like having a small storage capacity from an original stream with a high bit rate recorded in HDD or the like having a large storage capacity which is edited in units of pictures, for example, with minimum deterioration of the image quality by implementing 2-pass encoding.

Consequently, by encoding a decoded image immediately preceding an edit point and inserting a desired frame (insertion image) between edit points, it is possible to maintain the picture phase across the GOP boundary in the edit point. Further, because the insertion frame is a decoded image immediately preceding the edit point where the picture is displayed in pause, the complexity X for encoding the decoded image can be determined as a fraction of the complexity Dp or Db obtained from the original stream. The above process allows obtainment of the complexity of each picture for creating the edited coded stream ST1, thereby enabling the 2-pass encoding.

The present invention is not restricted to the above-mentioned embodiment, and various changes may be made without departing from the scope of the invention. For example, optional processing in each block shown in FIGS. 1 to 3 may be implemented by executing a computer program on CPU (Central Processing Unit). In such a case, the computer program may be stored in a recording medium or transmitted through a communication medium such as the Internet.

It is apparent that the present invention is not limited to the above embodiment that may be modified and changed without departing from the scope and spirit of the invention.

What is claimed is:

1. An image encoding apparatus comprising:
an editor for creating an editing instruction to edit a coded stream encoded from non-compressed video data at one or more edit point;
a decoding processor for decoding the coded stream in accordance with the editing instruction to create an edited stream; and
an encoding processor for re-encoding the edited stream to create an edited coded stream,
wherein the encoding processor creates the edited coded stream by aligning picture phases such that a picture type is the same in the same frame between the coded stream and the edited coded stream.

2. The image encoding apparatus according to claim 1, wherein
the encoding processor inserts an insertion image composed of a prescribed image in a position previous to and/or subsequent to the edit point in the edited stream to create the edited coded stream in such a way that a picture phase previous to and/or subsequent to the edit point is the same between the coded stream and the edited coded stream.

3. The image encoding apparatus according to claim 1, wherein
complexity for encoding and creating each picture in the coded stream is calculated by pre-analysis, and
the encoding processor encodes the decoded edited stream so as to reach a target code length in accordance with the complexity.

4. The image encoding apparatus according to claim 2, wherein
the insertion image is an image decoded from a picture contained in the coded stream, and
the encoding processor determines a target code length for encoding the insertion image based on complexity for encoding the picture.

5. The image encoding apparatus according to claim 2, wherein the encoding processor comprises:
an analyzer for analyzing complexity for encoding each picture constituting the coded stream; and
a code length allocator for allocating a target code length to each frame based on the analyzed complexity,
wherein the analyzer determines complexity of the insertion image based on complexity of a decoded image decoded from a picture contained in the coded stream and a picture type of the decoded image when encoded as the insertion image.

6. The image encoding apparatus according to claim 2, wherein
the coded stream is composed of a plurality of GOP (group of pictures) containing N number of pictures where N is an integer,
the editor creates the editing instruction such that a first edit point contained in a first GOP and a second edit point contained in a second GOP in the coded stream are played back in succession,
the decoding processor decodes the first GOP and decodes the second GOP,
the encoding processor inserts one or more insertion images between the first edit point and the second edit point, and sets a total number of pictures constituting a re-coded picture group containing pictures from a head picture of the first GOP to the first edit point, an insertion picture encoded from the one or more insertion images, and pictures from the second edit point to a final picture of the second GOP to an integral multiple of N.

7. The image encoding apparatus according to claim 6, wherein
if the total number of pictures constituting the re-coded picture group is less than N, the one or more insertion images are inserted so that the total number of pictures constituting the re-coded picture group reaches N.

8. The image encoding apparatus according to claim 6, wherein
if the total number of pictures constituting the re-coded picture group is greater than N, the one or more insertion images are inserted so that the total number of pictures constituting the re-coded picture group reaches 2N.

9. The image encoding apparatus according to claim 6, wherein
the insertion image is a first decoded image decoded from a first picture being a picture immediately previous to the first edit point.

10. The image encoding apparatus according to claim 6, wherein
the insertion image is a first decoded image decoded from a first picture being a picture immediately previous to the first edit point, and
the encoding processor creates the insertion picture by determining a target code length of the first insertion image based on complexity which is X/Dp when encoding the first insertion image to a P-picture and X/Db when encoding the first insertion image to a B-picture where complexity of the first picture is X, and 1<Dp≦Db.

11. The image encoding apparatus according to claim 10, wherein
the encoding processor creates the insertion picture by determining a target code length of the insertion image based on complexity which is complexity of an I-picture contained in the second GOP when encoding the first insertion image into an I-picture.

12. The image encoding apparatus according to claim 8, wherein
an image decoded from a first picture being a picture immediately previous to the first edit point is a first decoded image, an image decoded from a second picture being a picture immediately subsequent to the second edit point is a second decoded image,
the encoding processor inserts one or more first decoded picture immediately subsequent to the first edit point, creates GOP with a total number N of pictures containing pictures from a head picture of the first GOP to the first edit point and a first insertion picture encoded from the one or more first decoded picture, inserts one or more second decoded picture immediately previous to the second edit point, and creates GOP with a total number N of pictures containing a second insertion picture encoded from the one or more second decoded picture and pictures from the second edit point to a final picture of the second GOP.

13. The image encoding apparatus according to claim 2, wherein
the coded stream contains a second GOP having a second edit point in which pictures from a head picture of the second GOP to the second edit point are cut,
the editor edits the coded stream such that the second GOP comes at a head of the edited stream,
the decoding processor inserts one or more third insertion image being a prescribed image immediately previous to the second edit point and creates GOP with a total number N of pictures containing a third insertion picture encoded from the one or more third insertion picture and pictures from the second edit point to a final picture of the second GOP.

14. The image encoding apparatus according to claim 13, wherein
the third insertion image is a monochromatic image.

15. The image encoding apparatus according to claim 13, wherein
the third insertion picture is created by determining a target code length of the third insertion image based on complexity which is complexity of an I-picture contained in the second GOP when encoding the third insertion image into an I-picture.

16. The image encoding apparatus according to claim 13, wherein
the third insertion picture is created by determining a target code length of the third insertion image based on complexity which is predetermined complexity when encoding the third insertion image into a P-picture or a B-picture.

17. The image encoding apparatus according to claim 2, wherein
the coded stream contains a first GOP having a first edit point in which pictures from a first edit point to a final picture of the first GOP are cut,
the editor edits the coded stream such that a picture immediately previous to the first edit point of the first GOP comes at an end of the edited stream, and
the encoding processor inserts one or more fourth insertion image being a prescribed image immediately subsequent to the first edit point and creates GOP with a total number N of pictures containing pictures from a head picture of the first GOP to the first edit point and a fourth insertion picture encoded from the one or more fourth insertion picture.

18. The image encoding apparatus according to claim 17, wherein
the fourth insertion image is a first decoded image decoded from a first picture immediately previous to the first edit point.

19. An image encoding method for editing a coded stream encoded from non-compressed video data, comprising:
decoding a coded stream encoded from non-compressed video data so as to edit the coded stream at one or more edit point to create an edited stream; and
encoding the edited stream by aligning picture phases such that a picture type is the same in the same frame between the coded stream and the edited stream.

20. An image editing apparatus comprising:
an image encoding processor for editing a coded stream encoded from non-compressed video data; and
two or more storage devices for storing a coded stream;
the image encoding processor comprising:
an editor for creating an editing instruction to edit the coded stream stored in one storage device at one or more edit point;
a decoding processor for decoding the coded stream in accordance with the editing instruction to create an edited stream; and
an encoding processor for re-encoding the edited stream to create an edited coded stream,
wherein the encoding processor creates the edited coded stream by aligning picture phases such that a picture type is the same in the same frame between the coded stream and the edited coded stream, and
another storage device stores the edited coded stream.
